(19) United States
(12) Patent Application Publication
(10) Pub. No.: US 2025/0109821 A1
(43) Pub. Date: Apr. 3, 2025

(54) FOLDING SUPPORTING BRACKET

(71) Applicant: Guangzhou Haichuan Technology Development Co., Ltd., Guangzhou (CN)

(72) Inventor: Jinhua Cheng, Anqing (CN)

(21) Appl. No.: 18/978,093

(22) Filed: Dec. 12, 2024

(30) Foreign Application Priority Data
Dec. 2, 2024 (CN) 202422952906.5

(51) Int. Cl. F16M 13/00

(52) U.S. Cl. CPC F16M 13/005

(57) ABSTRACT

Folding supporting bracket is provided, including a connecting assembly and a supporting frame; the supporting frame is provided with a plastic plate; a reset spring is arranged between the supporting frame and the plastic plate; sliding rails are arranged in the connecting assembly; and the supporting frame is movably mounted in the sliding rails. The sliding rails, hardware sheets, and a hardware block are arranged in the connecting assembly. During use, the plastic plate can move along the sliding rails. Due to cooperative use of the hardware sheets, first springs, and second screws, an anti-breakage protection mechanism is formed. Therefore, when the bracket is pushed by an external force, the first springs can be pressed to move the hardware sheets, and the bracket is then directly folded. Breakage or damage of the bracket can be effectively avoided.

### TECHNICAL FIELD

The present disclosure relates to the technical field of brackets, and specifically, to a folding supporting bracket.

### BACKGROUND

Tablet computers or mobile phone protective cases are usually designed with brackets to facilitate users to use the devices in different scenarios. Most brackets are made of plastic or metal. Some brackets use a multi-angle adjustment design to meet different needs, such as watching videos, typing, or drawing. However, the brackets on the current market generally lack automatic reset function. When pushed by an external force, the brackets are easily damaged or broken due to the uneven force. This defect makes the brackets less durable in an unexpected situation, so that the brackets need to be improved.

### SUMMARY

The present disclosure aims to provide a folding supporting bracket, to solve the problems in the background section.

To achieve the above objectives, the present disclosure provides the following technical solution: A folding supporting bracket includes a connecting assembly and a supporting frame. The supporting frame is provided with a plastic plate; a reset spring is arranged between the supporting frame and the plastic plate; sliding rails are arranged in the connecting assembly; and the supporting frame is movably mounted in the sliding rails.

Two hardware sheets for limiting the supporting frame re movably connected into the connecting assembly; a first spring is arranged on each hardware sheet; and the hardware sheets and the first springs are combined to form an anti-breakage protection mechanism.

A hardware block is movably connected into the connecting assembly; a second spring sleeves the hardware block; and the hardware block and the second spring are combined to form a rail switching mechanism.

The connecting assembly is fixedly connected with a supporting platform through a plurality of groups of first screws; and honeycomb-shaped through holes are provided in the supporting platform.

Two ports are provided in the supporting platform; and a plurality of openings are provided in the connecting assembly.

The two hardware sheets are movably mounted on the connecting assembly through second screws; and the two hardware sheets can move along the second screws.

Steel strips are arranged at an upper end and a lower end of the plastic plate; the plastic plate is hinged on the supporting frame through the steel strip at the upper end; and the plastic plate is hinged on the connecting assembly through the steel strip at the lower end.

Grooves are provided in the supporting frame and the plastic plate; the reset spring is arranged in the grooves; and the reset spring sleeves the steel strip at the upper end of the plastic plate.

A hole is provided in the supporting frame; and an antiskid pad is fixedly connected to a bottom of the supporting frame.

Compared with the prior art, the present disclosure has the beneficial effects below:

The sliding rails, the hardware sheets, and the hardware block are arranged in the connecting assembly. During use, the plastic plate can move along the sliding rails. Through a rail switching mechanism composed of the hardware block and the second spring, in a process of unfolding the bracket, the plastic plate can be moved below the hardware sheets, so that the hardware sheets are used to limit the plastic plate, to achieve a supporting state for use. Due to cooperative use of the hardware sheet, a first spring, and a second screw, an anti-breakage protection mechanism is formed. Therefore, when the bracket is pushed by an external force, the first spring can be pressed to move the hardware sheet, and the bracket is then directly folded. Breakage or damage of the bracket can be effectively avoided. The bracket improves the defect that the existing bracket is easily broken and damaged by an external force during supporting and use, thereby reducing the damage rate of the bracket and prolonging the service life of the bracket.

### BRIEF DESCRIPTION OF THE DRAWINGS

FIG. 1 is an exploded view of a folding supporting bracket according to the present disclosure;

FIG. 2 is a diagram of an unfolded state of a folding supporting bracket according to the present disclosure;

FIG. 3 is a schematic three-dimensional structural diagram of a supporting platform in a folding supporting bracket according to the present disclosure;

FIG. 4 is a schematic three-dimensional structural diagram of a connecting assembly in a folding supporting bracket according to the present disclosure;

FIG. 5 is a schematic three-dimensional structural diagram of a supporting frame in a folding supporting bracket according to the present disclosure; and

FIG. 6 is a schematic three-dimensional structural diagram of a hardware block in a folding supporting bracket according to the present disclosure.

In the drawings: 10: supporting platform; 11: first screw; 12: honeycomb-shaped through hole; 20: connecting assembly; 21: sliding rail; 22: opening; 23: hardware sheet; 24: first spring; 25: second screw; 26: second spring; 27: hardware block; 30: supporting frame; 31: antiskid pad; 32: reset spring; 33: plastic plate; 34: steel strip; and 35: hole.

### DETAILED DESCRIPTION OF THE EMBODIMENTS

The technical solutions in the embodiments of the present disclosure are clearly and completely described below with reference to the accompanying drawings in the embodiments of the present disclosure. Apparently, the described embodiments are merely some embodiments of the present disclosure, rather than all of the embodiments. All other embodiments obtained by a person of ordinary skill in the art based on the embodiments of the present disclosure without making creative efforts shall fall within the protection scope of the present disclosure.

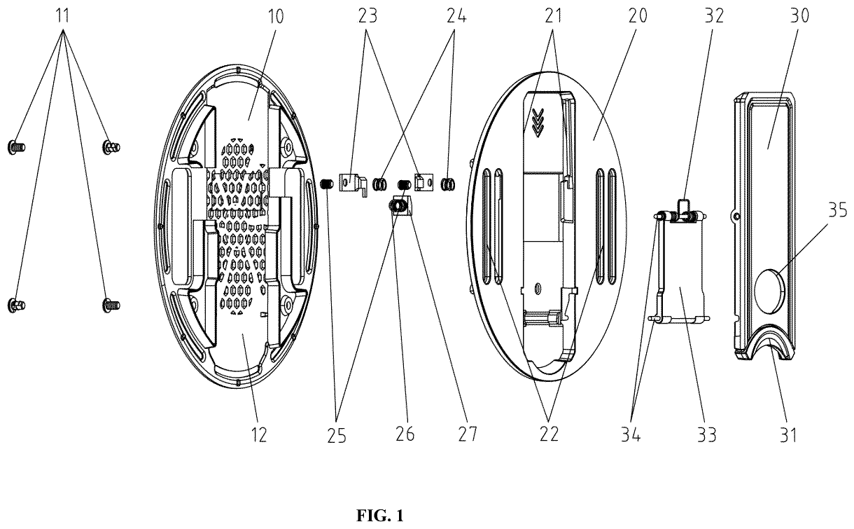

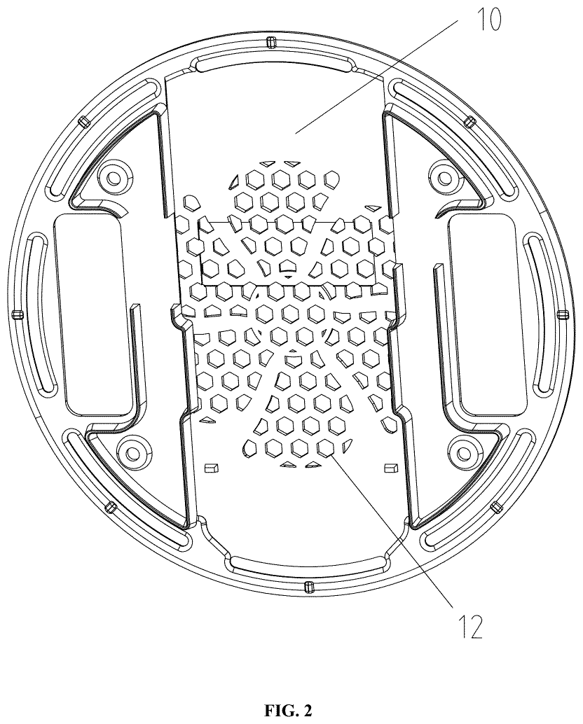

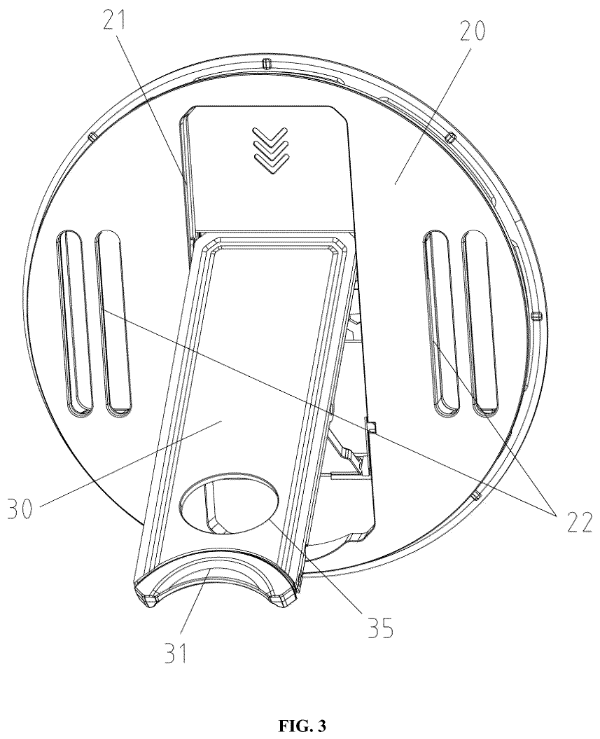

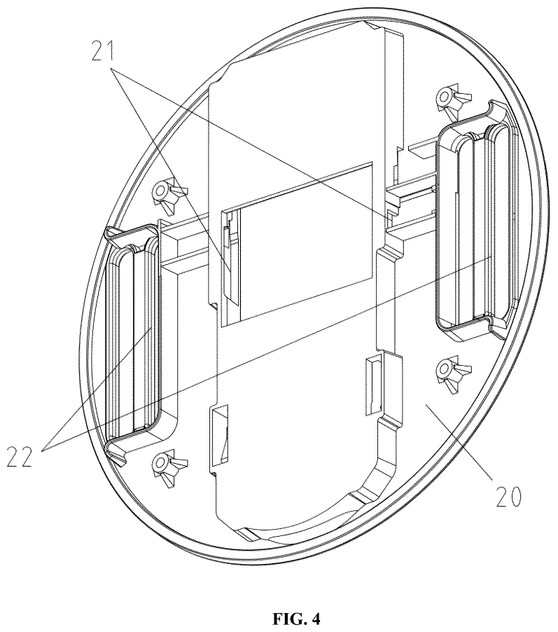

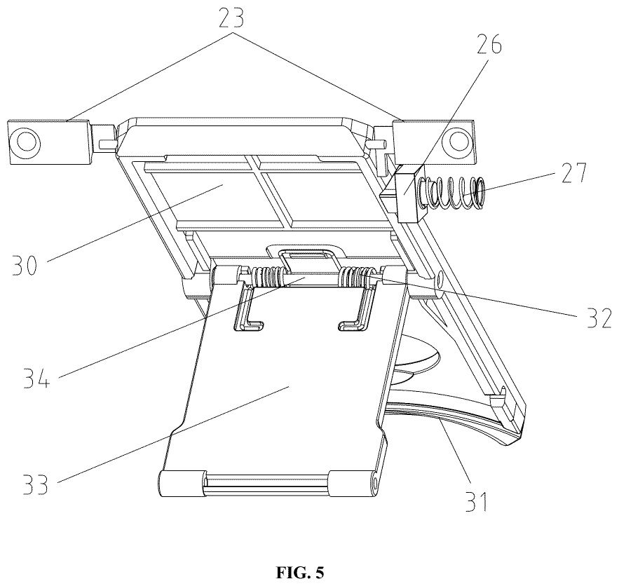

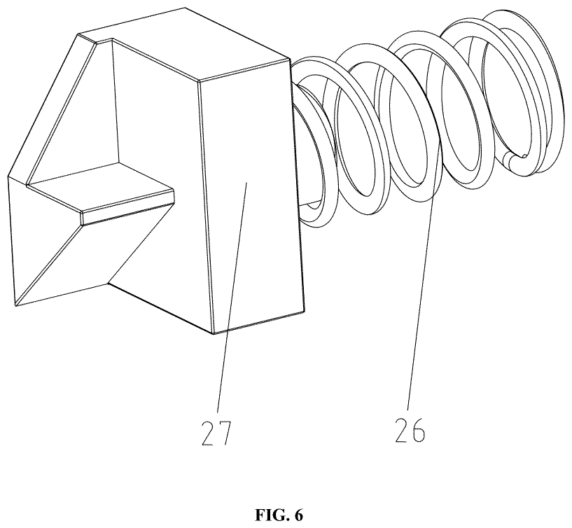

Referring to FIG. 1 to FIG. 6, the present disclosure provides a technical solution: A folding supporting bracket includes a connecting assembly 20 and a supporting frame 30. The supporting frame 30 is provided with a plastic plate 33. A reset spring 32 is arranged between the supporting frame 30 and the plastic plate 33. Sliding rails 21 are arranged in the connecting assembly 20. The supporting frame 30 is movably mounted in the sliding rails 21.

Two hardware sheets 23 for limiting the supporting frame 30 are movably connected into the connecting assembly 20. A first spring 24 is arranged on each hardware sheet 23. The hardware sheets 23 and the first springs 24 are combined to form an anti-breakage protection mechanism.

A hardware block 27 is movably connected into the connecting assembly 20. A second spring 26 sleeves the hardware block 27. The hardware block 27 and the second spring 26 are combined to form a rail switching mechanism.

The connecting assembly 20 is fixedly connected with a supporting platform 10 through a plurality of groups of first screws 11; and honeycomb-shaped through holes 12 are provided in the supporting platform 10. The honeycomb-shaped through holes 12 provided can enhance air circulation to achieve an effect of enhancing heat dissipation for used equipment.

Two ports are provided in the supporting platform 10; and a plurality of openings 22 are provided in the connecting assembly 20. Due to the arrangement of the openings 22, the connecting assembly 20 has a reserving function of adding an accessory, such as adding an adjustable wristband.

The two hardware sheets 23 are movably mounted on the connecting assembly 20 through second screws 25; and the two hardware sheets 23 can move along the second screws 25.

Steel strips 34 are arranged at an upper end and a lower end of the plastic plate 33. The plastic plate 33 is hinged on the supporting frame 30 through the steel strip 34 at the upper end; and the plastic plate 33 is hinged on the connecting assembly 20 through the steel strip 34 at the lower end.

Grooves are provided in the supporting frame 30 and the plastic plate 33. The reset spring 32 is arranged in the grooves. The reset spring 32 sleeves the steel strip 34 at the upper end of the plastic plate 33. By using the elastic characteristic of the reset spring 32, the supporting frame 30 can be automatically reset.

A hole 35 is provided in the supporting frame 30. An antiskid pad 31 is fixedly connected to a bottom of the supporting frame 30. Due to the arrangement of the hole 35, it can be convenient for a user to unfold the supporting frame 30. By using the antiskid pad 31, a better antiskid effect can be achieved during use of the supporting frame 30.

The working principle is as follows: When the bracket is unfolded, a top end of the supporting frame 30 moves along the sliding rails 21 in the connecting assembly 20. In the moving process, the second spring 26 and the hardware block 27 can be pushed to a position below the hardware sheets 23. The hardware sheets 23 are used to limit the supporting frame 30, so that the bracket is in a supporting state. When the bracket needs to be restored, the supporting frame 30 can be first pulled to bottoms of the sliding rails 21. In this case, under the action of the hardware block 27, the supporting frame 30 can return to the original rail. The bracket is then released. Under the action of the reset spring 32, the bracket can be automatically closed and reset. When the bracket is pushed by an external force, the first springs 24 can be triggered to drive the hardware sheets 23 to move. In this way, the bracket can be directly closed to avoid damage.

Although the embodiments of the present disclosure have been shown and described, it can be understood by those of ordinary skill in the art that various changes, modifications, substitutions, and variations can be made to these embodiments without departing from the principle and spirit of the present disclosure. The scope of the present disclosure is defined by the accompanying claims and their equivalents.

What is claimed is:

1. A folding supporting bracket, comprising a connecting assembly (20) and a supporting frame (30), wherein the supporting frame (30) is provided with a plastic plate (33); a reset spring (32) is arranged between the supporting frame (30) and the plastic plate (33); sliding rails (21) are arranged in the connecting assembly (20); the supporting frame (30) is movably mounted in the sliding rails (21);
two hardware sheets (23) for limiting the supporting frame (30) are movably connected into the connecting assembly (20); a first spring (24) is arranged on each hardware sheet (23); the hardware sheets (23) and the first springs (24) are combined to form an anti-breakage protection mechanism;
a hardware block (27) is movably connected into the connecting assembly (20); a second spring (26) sleeves the hardware block (27); and the hardware block (27) and the second spring (26) are combined to form a rail switching mechanism.

2. The folding supporting bracket according to claim 1, wherein the connecting assembly (20) is fixedly connected with a supporting platform (10) through a plurality of groups of first screws (11); and honeycomb-shaped through holes (12) are provided in the supporting platform (10).

3. The folding supporting bracket according to claim 2, wherein two ports are provided in the supporting platform (10); and a plurality of openings (22) are provided in the connecting assembly (20).

4. The folding supporting bracket according to claim 1, wherein the two hardware sheets (23) are movably mounted on the connecting assembly (20) through second screws (25); and the two hardware sheets (23) are capable of moving along the second screws (25).

5. The folding supporting bracket according to claim 1, wherein steel strips (34) are arranged at an upper end and a lower end of the plastic plate (33); the plastic plate (33) is hinged on the supporting frame (30) through the steel strip (34) at the upper end; and the plastic plate (33) is hinged on the connecting assembly (20) through the steel strip (34) at the lower end.

6. The folding supporting bracket according to claim 5, wherein grooves are provided in the supporting frame (30) and the plastic plate (33); the reset spring (32) is arranged in the grooves; and the reset spring (32) sleeves the steel strip (34) at the upper end of the plastic plate (33).

7. The folding supporting bracket according to claim 1, wherein a hole (35) is provided in the supporting frame (30); and an antiskid pad (31) is fixedly connected to a bottom of the supporting frame (30).
